(19) United States
(12) Patent Application Publication
(10) Pub. No.: US 2016/0158985 A1
(43) Pub. Date: Jun. 9, 2016

(54) CONTROL SYSTEM FOR INJECTION MOLDING

(71) Applicant: Extrude To Fill, LLC, Maple Park, IL (US)

(72) Inventor: Richard Ernest Fitzpatrick, Loveland, CO (US)

(21) Appl. No.: 14/960,101

(22) Filed: Dec. 4, 2015

Related U.S. Application Data
(60) Provisional application No. 62/087,414, filed on Dec. 4, 2014.
(60) Provisional application No. 62/087,449, filed on Dec. 4, 2014.
(60) Provisional application No. 62/087,480, filed on Dec. 4, 2014.

(51) Int. Cl. B29C 45/76; G05B 19/042; H02K 7/14

(52) U.S. Cl. CPC B29C 45/76; H02K 7/14; G05B 19/042; G05B 2219/2624

(57) ABSTRACT

An injection molding apparatus and a control method are provided. The apparatus may include a barrel connected to a hopper for receiving a material from the hopper. The apparatus may include one or more heaters outside the barrel. The apparatus may include an extrusion screw inside the barrel. The apparatus may include a motor coupled to one end of the extrusion screw to rotate the extrusion screw and a torque sensor on the motor. The apparatus may include a controller coupled to the motor and the heaters. The controller may be configured to receive signals from the torque sensor. The controller may include a control algorithm to adjust the one or more heaters according to the signal from the torque sensor to melt the material inside the barrel.

### CROSS-REFERENCES TO RELATED PATENT APPLICATIONS

This patent application claims the benefit under 35 U.S.C. 119(e) of U.S. Provisional Patent Application No. 62/087,414, entitled “Extrude-to-Fill Injection Molding and Extrusion Screw,” and filed on Dec. 4, 2014, U.S. Provisional Patent Application No. 62/087,449, entitled “Nozzle Shut-off for Extrude-to-Fill Injection Molding System,” and filed on Dec. 4, 2014, and U.S. Provisional Patent Application No. 62/087,480, entitled “Control System for Extrude-to-Fill Injection Molding,” and filed on Dec. 4, 2014, each of which is hereby incorporated herein by reference in its entirety.

### FIELD

The present disclosure is directed to an injection molding system. More specifically, the present disclosure is directed to a control system for automatic startup, in-process monitoring, and operation control for the disclosed system.

### BACKGROUND

A traditional injection molding system requires an experienced operator to start up the system and set up the parameters to operate the system to mold parts. For example, the experienced operator may provide an initial machine configuration including screw rotation speed, barrel temperature, and injection velocity according to a material type. The process settings for each plastic may vary. It is difficult to mold a material with unknown composition. Therefore, it requires trial and error for the experienced operator to determine the proper operating settings for molding the material. Yet, the quality of the parts may not be controllable, such that the production yield may not be high, especially for the material with unknown compositions.

It is also expensive to manually start the traditional injection molding system. Due to the need to generate shear heat to fully melt the plastic, a purging process is required to manually prepare the machine for molding parts by the operator. The operator may manually cycle the traditional injection molding system to allow the plastic melt to fall onto a machine bed until the operator determines whether the output plastic is hot enough to commence molding parts. Subsequently, quantities of parts are produced for inspection and analysis to determine if the machine is configured appropriately to produce parts having the intended characteristics. When the parts meet the required specifications, the machine settings are fixed for mass production. The process may become stable without significant temperature drift after about 2-6 hours of operation. The traditional injection molding machine includes a proportional-integral-derivative (PID) controller to set and hold desired heater values for the band heaters on the extrusion barrel.

Modern sensor technologies are largely ineffective in controlling a traditional injection molding machine because key data cannot be timely collected for improving the molding process. Also, the resin properties, such as melt flow viscosity, may vary largely due to shear heat generation in the traditional injection molding machine. Without in-process control of the molding operation, it is difficult to control the consistency or quality of the molded parts.

Documents that may be related to the present disclosure in that they include various injection molding systems include U.S. Pat. No. 7,906,048, U.S. Pat. No. 7,172,333, U.S. Pat. No. 2,734,226, U.S. Pat. No. 4,154,536, U.S. Pat. No. 6,059,556, and U.S. Pat. No. 7,291,297. These proposals, however, may be improved.

It is desirable to develop a system that is less dependent on an operator's experience as well as trial and error to configure the molding system. It is also desirable to develop more cost effective systems and operation methods for consistently producing parts of high quality.

### BRIEF SUMMARY

The present disclosure provides a control system for automatic startup, in-process monitoring, and/or operation control for an injection molding system, which may be referred to herein as an extrude-to-fill (ETF) injection molding apparatus, machine, or system.

In an embodiment, an extrude-to-fill injection molding apparatus is provided. The apparatus may include a barrel connected to a hopper for receiving a material from the hopper. The apparatus may include one or more heaters outside the barrel. The apparatus may include an extrusion screw inside the barrel. The apparatus may include a motor coupled to one end of the extrusion screw to rotate the extrusion screw and a torque sensor on the motor. The apparatus may include a controller coupled to the motor and the heaters. The controller may be configured to receive signals from the torque sensor. The controller may include a control algorithm to adjust the one or more heaters according to the signal from the torque sensor to melt the material inside the barrel.

In an embodiment, an automatic control method for an ETF injection molding system is provided. The method may include receiving a material type and a part size in a controller comprising a control algorithm. The method may include selecting operating parameters by the control algorithm according to the material type and the part size. The operating parameters may include a barrel temperature and a screw rotation speed. The method may include switching on one or more heaters to heat a material inside the barrel to the selected barrel temperature, and activating a motor to rotate the extrusions screw inside the barrel at the selected screw rotation speed. The motor may be coupled to an end of an extrusion screw inside a barrel. The method may include adjusting the one or more heaters to melt the material, and molding a part.

Additional embodiments and features are set forth in part in the description that follows, and will become apparent to those skilled in the art upon examination of the specification or may be learned by the practice of the disclosed subject matter. A further understanding of the nature and advantages of the present disclosure may be realized by reference to the remaining portions of the specification and the drawings, which forms a part of this disclosure.

The present disclosure is provided to aid understanding, and one of skill in the art will understand that each of the various aspects and features of the disclosure may advantageously be used separately in some instances, or in combination with other aspects and features of the disclosure in other instances. Accordingly, while the disclosure is presented in terms of embodiments, it should be appreciated that individual aspects of any embodiment can be claimed separately or in combination with aspects and features of that embodiment or any other embodiment.

### BRIEF DESCRIPTION OF THE DRAWINGS

The description will be more fully understood with reference to the following figures and data graphs, which are presented as various embodiments of the disclosure and should not be construed as a complete recitation of the scope of the disclosure, wherein:

FIG. 1 is an automatic injection molding system diagram in accordance with embodiments of the present disclosure.

FIG. 2 is a flow chart illustrating steps for automatically starting the injection molding system in accordance with embodiments of the present disclosure.

FIG. 3 is a flow chart illustrating the steps for molding a part in accordance with embodiments of the present disclosure.

FIG. 4 is a block diagram illustrating an algorithm for heater control based upon the torque load on the extrusion screw of the injection molding system in accordance with embodiments of the present disclosure.

FIG. 5 is a block diagram illustrating an algorithm for heater control based upon input material in accordance with embodiments of the present disclosure.

### DETAILED DESCRIPTION

The present disclosure may be understood by reference to the following detailed description, taken in conjunction with the drawings as described below. It is noted that, for purposes of illustrative clarity, certain elements in various drawings may not be drawn to scale.

The present disclosure provides a control system or a controller for an injection molding system, which may be referred to herein as an extrude-to-fill (ETF) injection molding apparatus, machine, or system. The controller can automatically start the ETF injection molding system and can also dynamically adjust operating parameters according to materials and machine conditions to achieve high quality, uniform density injection molded parts and products.

The present disclosure provides devices and methods for in-process monitoring. The real time adjustment may be accomplished by using the controller that processes data collected from various sensors. The operating conditions may be adjusted from an operating baseline if the material deviates from desired viscosity. One of the important processing parameters is resin viscosity that is temperature dependent, which affects mold filling and part quality. Another important processing parameter is pressure, which affects the uniformity of part density or part warp.

The present ETF injection molding system is different from the traditional injection molding system in several aspects. For example, the ETF molding system is less sensitive to material purity level, material cleanliness, contaminants, resin grades, or unknown sources than the traditional system. The materials for molding may include any petroleum-based or non-petroleum-based thermoplastics, amorphous thermoplastics, crystalline and semi-crystalline thermoplastics, virgin resins, fiber reinforced thermoplastics, post-industrial recycled resins, post-consumer recycled resins, mixed and comingled thermoplastic resins, organic resins, organic food compounds, carbohydrate based resins, sugar-based compounds, gelatin, propylene glycol, starch based compounds, metal injection molding (MIM) feedstocks, among others. The material may be in form of pellets or flakes or any irregular shapes.

The traditional injection molding system provides a fixed sequential process for filling a mold, whereas the present ETF system may provide a concurrent process for filling a mold. Although the total cycle time may be comparable to the traditional system, the present ETF injection molding system may have a slower mold fill rate than the traditional injection molding system. For example, the ETF injection molding system may fill a mold in 3 seconds, compared 1 second for the traditional molding. The fill time may increase with part size for the same ETF injection molding system but may be varied with changes to the screw diameter or screw length. The slower mold fill rate can be achieved by the ETF system due to not being restricted to the injection cycle, separate from the extrusion recovery cycle in traditional injection molding. The ETF system can extrude to fill the mold cavity, continuous and on demand, as it is not restricted to a shot size determined by the volume of the injection chamber.

The lower pressure and material velocity to fill the mold allows the ETF system to make real time changes to the machine settings by using sensor data to achieve uniform resin flow during molding. The uniform resin flow and the lower pressure may produce parts of uniform density and consistency, reduce degradation of materials, and shorten the mold cooling cycle.

The present ETF injection molding system primarily uses static heat generation to melt the material rather than the shear heat generation primarily used by traditional injection molding systems. In other words, the ETF injection molding system melts the material into a condition in which the material is ready for extrusion without rotating or otherwise moving the extrusion screw, and without a purging process. By using static heat generation, and not shear or frictional heat generation, the machine may be integrated into an assembly line (for example, a medical device or electronic assembly line) and produce parts on demand, without a subjective and time-consuming start-up process. The ETF injection molding system has a much thinner barrel wall than the traditional injection molding system, which is due to a significantly lower pressure required to inject the resin melt into a mold than the traditional injection molding system.

The injection molding system may include automated start-up and production molding. In other words, a technician or machine operator is not required for start-up of the molding machine or part production. Rather, sensors may measure physical states of the molding machine and one or more controllers operably coupled to the sensors may adjust machine settings during operation to deliver a consistent, on-demand result. The one or more controllers may be connected to networks to facilitate remote control of the controllers by individuals in other locations or by other machines or automation lines that are associated with the machine to provide molded parts on demand as needed by the assembly line of which it is included. The injection molding system may intermittently produce parts as needed by the operator or the assembly line, and remain idle when not producing parts, without requiring a purging process after idle periods of time.

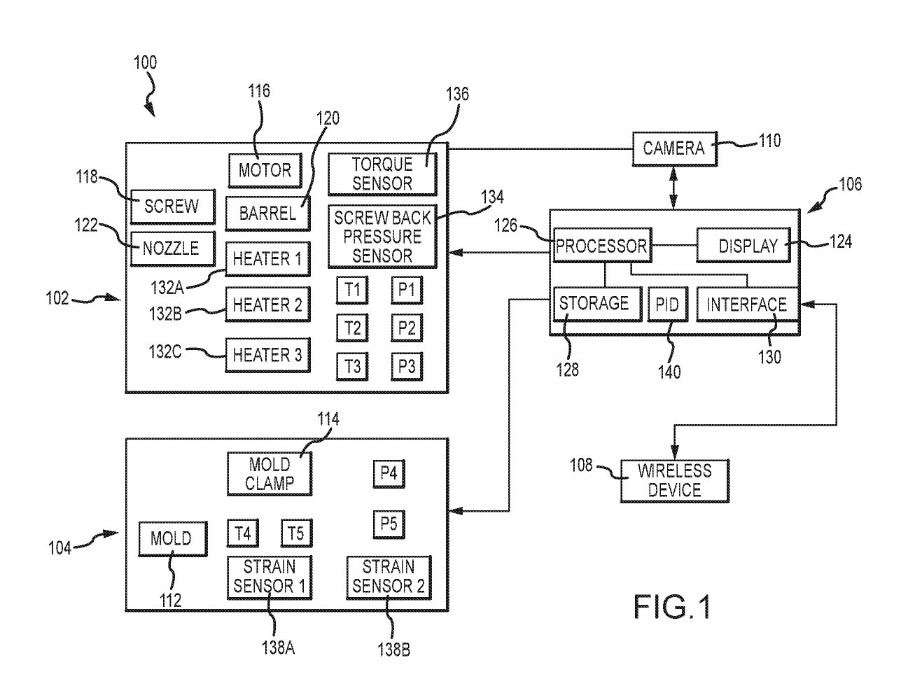

FIG. 1 is an automatic extrude-to-fill (ETF) injection molding system diagram in accordance with embodiments of the present disclosure. An ETF injection molding system 100 includes an injection system 102 coupled to or associated with a mold system 104. The ETF injection molding system 100 also includes a controller 106 coupled to the injection system 102 and the mold system 104 to automatically start the operation of the extrusion system and make real time dynamic adjustments through the processor 126 based on the inputs from the injection system 102 and mold system 104.

The controller 106 may monitor the temperature and pressure, and torque load from various sensors in the injection system 102. For example, a torque sensor 136 at an end of the extrusion screw 118 may provide feedback on the torque load to the controller 106. The torque load may provide an indication of the resin viscosity.

The torque sensor 136 may utilize motor currents 116 to provide real-time monitoring of resin viscosity. For example, motor currents may be measured by a variable frequency drive when using an inverter duty three-phase motor or a servo or stepper motor drive. The resin viscosity may affect screw rotation. Specifically, higher resin viscosity may increase the torque load for a motor that drives the screw, such that the motor current draw would increase, which suggest high resin viscosity. The motor current may provide indirect measurement of the resin viscosity more quickly and accurately than the thermocouples that measure resin temperatures at various locations. For a relatively cold resin with higher viscosity, more current draw may be required for the motor to overcome higher torque load. Although the thermocouples can provide the temperature to the controller, the information is often delayed, such that the controller cannot adjust the heaters timely.

By monitoring the resin viscosity in real time, the controller 106 can adjust heaters 132A-C to provide the resin melt with a desired viscosity. When the increase in the resin viscosity is observed, the controller 106 may override a PID heater 140 in the controller 106 to timely adjust the heaters, such as resistance heaters or induction heaters, to reduce the resin viscosity.

For the ETF injection molding system 100, the controller 106 does not require the accurate information of the melt flow index or heat history because of the static heat conduction and the capability of real time adjustment of resin viscosity.

The screw back pressure sensor 134 attached at the end of the extrusion screw 118 may also provide the load on the extrusion screw, which may indicate whether the mold 112 is filled. Thermal sensors T1, T2, or T3 or more, such as thermocouples, may be placed in various locations along the extrusion screw 118 inside the barrel 120 to indicate resin temperatures. The variations between the thermal sensors T1, T2, T3 may be monitored and recorded to adjusting processing. The controller 106 may also monitor the pressure by one or more pressure sensors, such as pressure sensors P1, P2, P3, which may be placed inside the extrusion barrel 120 along the screw 118 to monitor resin pressures.

The controller 106 may be coupled to the mold system 104 to automatically detect the status of the mold system 104. For example, pressure sensor P4 may be placed near the nozzle 122 of the injection system to monitor pressure.

Pressure sensor P5 may be placed inside a mold or mold cavity 112 to directly monitor the pressure inside the mold. The pressure sensors P4 and P5 may send signals to the controller 106, which may determine if the mold 112 is filled. In some embodiments, the injection molding system may generate the same pressure as the pressure in the mold cavity or a slightly higher injection pressure, such as 5-10% higher injection pressure, than the pressure in the mold cavity. Such indication from pressure sensors P4 and P5 may cause the controller 106 to move the screw 118 or barrel 120 and seal the screw tip and nozzle to stop flow of molten material into the mold 112. In some embodiments, the controller 106 may reverse screw rotation to move the screw in an axial direction and seal the nozzle. The controller 106 may automatically control clamping and unclamping of the mold clamp 114 of the mold system 104. Clamping and unclamping may be achieved in various manners, which may include, but are not limited to, applying a pneumatic clamping force (e.g., an air pressure based actuation system), a mechanical clamping force (e.g., a mechanical clamp), and/or an electrical clamping force (e.g., a servomotor-based actuation system). In some embodiments, the controller 106 may apply air pressure or release air pressure to the mold clamp 114 to control clamping and unclamping. In embodiments using air pressure, the air pressure may vary depending on the size of the mold. In some embodiments, the air pressure may range from 90 psi to 110 psi. Thermal sensors T4 and T5 or more sensors may be placed at various locations within the mold 112 to detect the temperatures, which may provide feedback on part uniformity to the controller 106.

The controller 106 may dynamically adjust the processing settings of the band heaters or resistance heaters, such as heaters 132A-C, or adjust the processing settings of the resistor heater inside the extrusion screw or inductive heaters. The controller 106 may also control rotation of the motor 116, such as starting rotation, reversing rotation, and stopping rotation, based upon the feedback from the various sensors in the injection system 102 and the mold system 104. The extrusion screw 118 of the injection system 102 can rotate both clockwise and counter-clockwise.

The controller 106 may control the ETF injection molding system 100 to operate by different modes. In one mode, the ETF injection molding system 100 may extrude for a period of extrusion time, which is one of the common parameters for controlling the resin volume extruded into the mold. In another mode, the ETF injection molding system may extrude for a number of screw rotations. The number of screw rotations may be determined by the part size or material volume extruded into the mold.

The controller 106 can automatically start the molding cycle for the ETF injection molding system. The resin may be heated by the heaters to a melt state by heat conduction without purging, which is required by the traditional injection molding system. The resin temperature may be directly monitored by thermocouples T1, T2, T3 or more, which may be placed in the melt or indirectly monitored by the torque load detected by the torque sensor 136 during the screw rotations.

The present controller 106 may include a display 124, such as a touchscreen, as a user interface. On the display 124, an operator may input the material or resin type, which sets a baseline temperature controlled by heaters 132A-C. The operator may input the part size to be molded, which determines a baseline extrusion time or baseline number of rotations. Larger parts may take a longer time or a higher number of rotations to extrude for an ETF injection molding system.

A pumping efficiency is a measure of material volume flowing into the mold per unit time, which may increase with screw diameter or screw length for the extrusion screw. The rotation speed may also affect the pumping efficiency.

The injection system 102 may include an extrusion screw back pressure sensor 134, which may indicate whether a mold cavity is fully filled. The controller 106 may monitor a screw back pressure measured by the screw back pressure sensor 134 attached to the end of the extrusion screw 118. When the screw back pressure increases sharply, it may indicate that the mold cavity is filled with the melt. The increase in the screw back pressure may be used as an indicator of a filled mold only after the injection system 102 extrudes for a number of screw rotations or a period of time.

The controller 106 may monitor the strain sensed in machine frame side rails as shown in FIG. 1 by using sensors 138A and 138B. The frame side rails sustain the load from both the mold system 104 and injection system 102. The tensile load may be measured by measuring the strain on the mold clamp 114 and the frame side rails.

Spikes in motor torque load or screw back pressure may occur. For example, when molding mixed recycled resins or resins with different melt flow indexes, irregular data may be shown from the screw back pressure and/or motor torque. In this case, a baseline may be obtained by monitoring the tension on the machine frame side rails. The spikes in motor torque load or screw back pressure may be ignored or discarded until the tension or tensile load on the frame side rails is achieved. When the mold 112 is filled with molten material, the internal pressure inside the mold 112 causes the tension on the frame side rails, which may be detected by the strain sensors 138A-B.

The controller 106 may include a proportional-integral-derivative (PID) temperature controller 140 that uses one or more thermocouples to establish the baseline operating temperature, but the temperature may be a delayed indicator of actual resin temperature, and may not be as effective as resin viscosity which can be indirectly measured through the motor torque or motor current.

According to the input of the material type and the part size, the controller for the EFT system may include a control algorithm that can override the PID temperature controls and adjust heaters according to the resin viscosity, which is monitored from the extrusion motor current. For example, resin viscosity may increase the motor torque load, such that an increase in the motor torque load may be used to trigger an increase in heat generation applied to the screw and barrel. A reduction in the motor torque load may trigger a decrease in the heat generation.

The controller 106 may include a network interface 130, such as a wireless connection, to communicate with a wireless device 108. The controller 106 may be remotely controlled for operations, including automatically starting machine, monitoring data, instructing, debugging, or reviewing data for historical records of part quality, and/or upgrading software including a control algorithm. The wireless connection may allow for the software to be erased if it is necessary to protect the software from being stolen.

These data points may be established as a process metric through experiments and then may be stored in a memory device 128 of the controller 106 as a record of production. The data from various sensors may be used alone or in combination.

The present ETF injection molding system 100 may include one or more cameras 110 to video the molding operations, and/or capture images of molded parts, among others. The videos or images may be stored in the memory device 128 or may be received by the wireless device 108. An expert may remotely perform troubleshooting.

The present ETF injection molding system 100 does not require a tight clearance between the screw outside diameter and the barrel inside diameter. The clearance may be needed for the extrusion screw 118 to rotate freely within the barrel 120. The clearance may be large enough to prevent material from being sheared between the barrel 120 and the extrusion screw 118, unlike the traditional injection molding system. The extrusion screw 118 may rotate to move backward a small axial distance to open the nozzle 122. The extrusion screw 118 may rotate reversely to move forward the small axial distance to shut off or close the nozzle 122 when a forward extrusion is halted by the mold cavity 112 being filled of plastic. In addition or alternative to axial movement of the screw 118, the barrel 120 may move an axial distance relative to the extrusion screw 118 to open and close the nozzle 122.

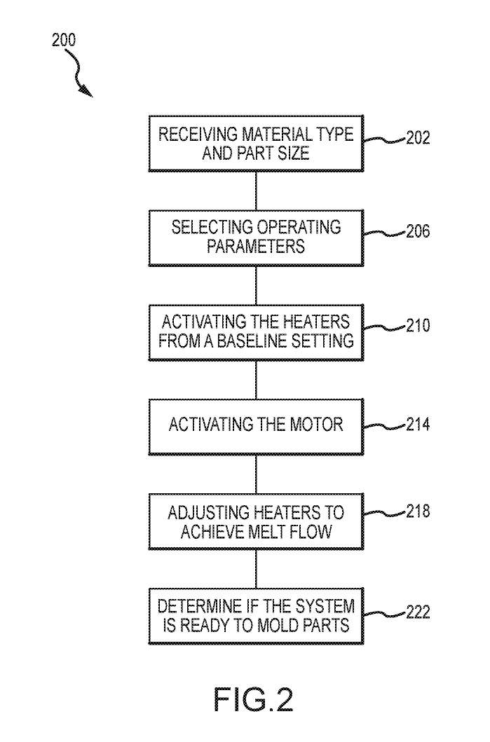

FIG. 2 is a flow chart illustrating steps for automatically starting the injection system 102 in accordance with embodiments of the present disclosure. Method 200 includes various steps 202 to 222 for starting the injection system. The controller 106 may receive the material and part size at step 202. For example, a user may enter at the display that the material to be molded is polyethylene (PE) and the part size or shot size is 5 grams. The controller 106 may determine if it is crystalline thermoplastic or an amorphous plastic based on information from a database. The database may contain temperature requirement, melt viscosity, pumping pressure, amongst other parameters specific to the material being processed without limit to material type.

The controller 106 may select operating parameters at step 206, such as rotating speed, a number of rotations or screw extrusion time, and temperature setting for the heaters 132A-C. Then, the controller 106 may activate all the heaters or selected heaters according to the selected temperature settings at step 210 and may activate the motor 116 at step 214.

The controller 106 may optionally adjust the heaters 132A-C by monitoring the real time viscosity using torque load to achieve uniform melt flow. When the melt flow is achieved, no spikes or sharp increases are observed in the torque load after the heaters are turned on and the screw rotates for a period of time, which may suggest that the melt is ready for molding parts. Then, the controller 106 may determine if the system is ready for molding parts at step 222.

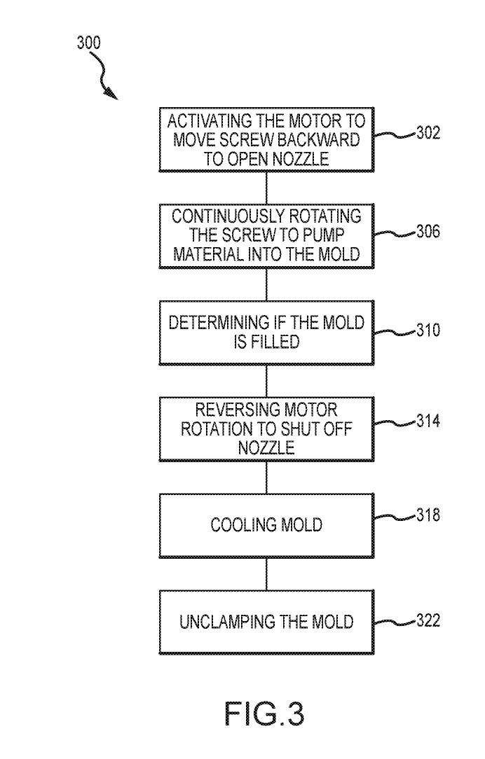

FIG. 3 is a flow chart illustrating the steps for a molding cycle in accordance with embodiments of the present disclosure. For each molding cycle 300, the controller 106 may activate the motor 116 to move the extrusion screw 118 backward to open the nozzle 122 at step 302. In addition or alternative to moving the extrusion screw 118 at step 302, the controller 106 may activate a cylinder operably coupled to the barrel 120 to move the barrel 120 forward relative to the extrusion screw 118 to open the nozzle 122 at step 302. The controller 106 may then continuously rotate the extrusion screw 118 without any axial movement to pump the material from the hopper into the mold cavity 112 at step 306. The controller 106 may determine if the mold 112 is filled at step 310, for example, by using the back pressure sensor 134 in the injection system 102 and/or the pressure sensors P4 and P5 in the mold system 104. The controller 106 may reverse the rotation of the motor 116 to move the extrusion screw 118 forward to close or shut off the nozzle 122 at step 314, followed by cooling the mold 112 to allow the material in the mold 112 to solidify at step 318 and unclamping the mold at step 322 by, for example, releasing the air pressure in the mold clamp 114. In addition or alternative to moving the extrusion screw 118 at step 314, the controller 106 may move the barrel 120 backward or rearward relative to the screw 118 to close or shut off the nozzle 122.

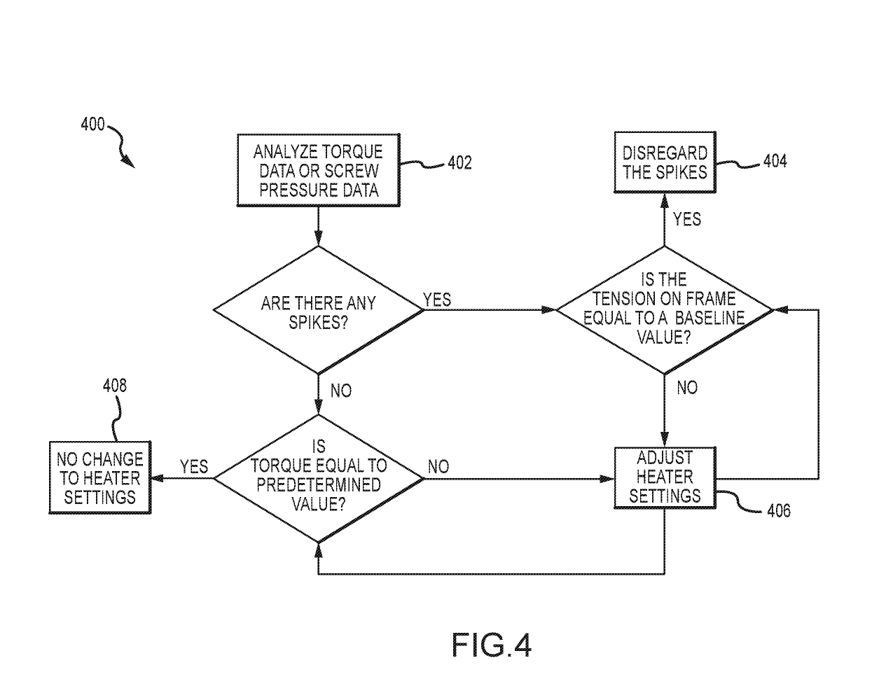

FIG. 4 is a block diagram illustrating an algorithm for heater control according to data from torque sensor and strain sensors. An algorithm 400 starts with analyzing the torque load data from the torque sensor 136 by the processor 126 at step 402. If there are no spikes in the torque load data, the algorithm 400 may check to determine if the torque is equal to a predetermined value. If the torque is equal to the predetermined value, no change in heater settings is required 408. But, if the torque does not equal the predetermined value, the processor 126 may adjust the heater settings 406. If there are spikes in the torque load data, the algorithm 400 may check to see if the tension on the frame is equal to a baseline value. When the baseline value is achieved, the algorithm 400 may disregard the spikes at step 404. When the baseline value is not achieved, the algorithm 400 may cause the processor 126 to adjust the settings of the heaters 132A-C at step 406 until the tension on the frame is equal to a baseline value. The block diagram in FIG. 4 illustrates a configuration in which the baseline value is set to the tension on the frame when the mold is full. Conversely, in configurations in which the baseline value is set to the tension on the frame when the mold is empty, the control logic associated with disregarding the spikes 404 and adjusting heater settings 406 is reversed. In other words, when the tension on the frame is equal to a baseline value based on an empty mold, the algorithm 400 may cause the processor 126 to adjust the settings of the heaters 132A-C at step 406. When the tension on the frame is not equal to a baseline value based on an empty mold, the algorithm 400 may disregard the spikes at step 404.

When a material is entered into the controller 106 by a user, the heaters 132A-C may be automatically set up to the temperature above the melting temperature. Some of the heaters 132A-C may be turned off depending upon the material type. For example, a semi-crystalline plastic may be heated faster than an amorphous plastic. For the semi-crystalline plastic, one or more heaters may be turned off or deactivated.

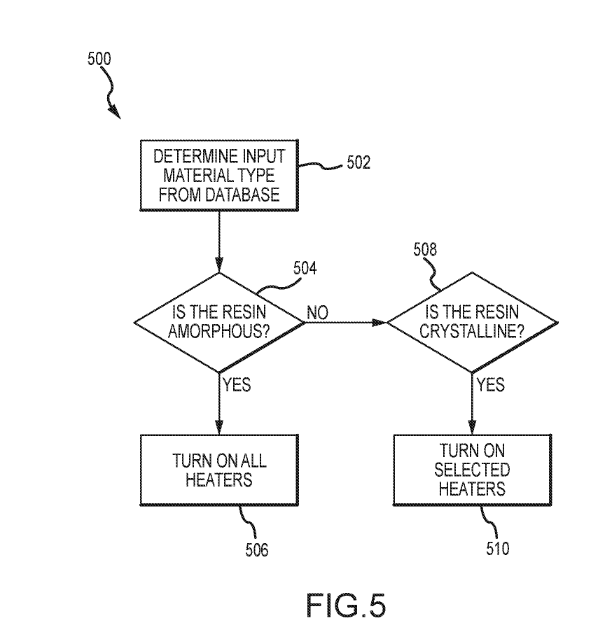

FIG. 5 is a block diagram illustrating an algorithm 500 for heater control according to material type. The controller 106 receives an input of material from a user through the display 124. The controller 106 may include a database in the memory device 128, which stores various plastic and classifies the plastic in either amorphous or crystalline. The algorithm 500 determines the input material type according to the database at step 502. The material may be amorphous, semi-crystalline, or crystalline. For example, semi-crystalline or crystalline plastics may include nylon, polypropylene (PP), polyethylene (PE), polyethylene-terephthalate (PET), among others. These crystalline or semi-crystalline thermoplastics are molten above their melting peaks or melting points. The amorphous thermoplastics, such as polycarbonate (PC) or ABS, may be molten about their glass transition temperatures.

The controller 106 may turn on all the heaters 132A-C if the material is amorphous at step 506. The controller 106 may turn on selected heaters, such as heaters near the nozzle and turn off the heater near the hopper, if the material is semi-crystalline at step 508.

The controller 106 may also monitor extrusion motor torque load. The extrusion screw 118 may have a predetermined profile of torque loads for various materials to be extruded. A torque load may increase during the molding cycle, which may indicate that the resin viscosity is high and may suggest a heater adjustment. The torque load may sharply increase during a late stage of the molding cycle, which may indicate that the mold is filled with plastic and may cause the screw to reverse, or the barrel to move, and close the nozzle.

Having described several embodiments, it will be recognized by those skilled in the art that various modifications, alternative constructions, and equivalents may be used without departing from the spirit of the invention. Additionally, a number of well-known processes and elements have not been described in order to avoid unnecessarily obscuring the present invention. Accordingly, the above description should not be taken as limiting the scope of the invention. All of the features disclosed can be used separately or in various combinations with each other.

Those skilled in the art will appreciate that the presently disclosed embodiments teach by way of example and not by limitation. Therefore, the matter contained in the above description or shown in the accompanying drawings should be interpreted as illustrative and not in a limiting sense. The following claims are intended to cover all generic and specific features described herein, as well as all statements of the scope of the present method and system, which, as a matter of language, might be said to fall there between.

1. An apparatus comprising:
a barrel connected to a hopper for receiving a material from the hopper;
one or more heaters outside the barrel;
an extrusion screw inside the barrel;
a motor coupled to one end of the extrusion screw to rotate the extrusion screw;
a torque sensor on the motor; and
a controller coupled to the motor and the heaters, the controller configured to receive signals from the torque sensor, the controller comprising a control algorithm to adjust the one or more heaters according to the signal from the torque sensor to melt the material inside the barrel.

2. The apparatus of claim 1, further comprising strain sensors attached to the frame that supports a mold.

3. The apparatus of claim 1, further comprising thermal sensors inside the barrel.

4. The apparatus of claim 1, further comprising pressure sensors inside the mold and a back pressure sensor attached at the end of the extrusion screw.

5. The apparatus of claim 1, wherein the controller comprises a display as a user interface.

6. The apparatus of claim 1, further comprising a wireless device in communication with the controller.

7. The apparatus of claim 1, wherein the controller comprises a processor and a memory device.

8. The apparatus of claim 1, wherein the controller comprises a network interface.

9. The apparatus of claim 1, further comprising a camera for capturing images or videos in communication with the controller to help remote trouble shooting.

10. An automatic control method for a molding system, the method comprising:
receiving a material type and a part size in a controller including a control algorithm;
selecting operating parameters by the control algorithm according to the material type and the part size, the operating parameters comprising a barrel temperature and a screw rotation speed;
switching on one or more heaters to heat a material inside the barrel to the selected barrel temperature;
activating a motor to rotate an extrusion screw inside the barrel at the selected screw rotation speed, the motor being coupled to an end of an extrusion screw inside a barrel;
adjusting the one or more heaters to melt the material; and
molding a part.

11. The method of claim 10, the operation of adjusting the heaters comprising:
determining if the material comprises a temperature sensitive material based upon a database; and
adjusting the one or more heaters when the temperature sensitive material is confirmed.

12. The method of claim 10, the operation of adjusting the heaters comprising:
analyzing to determine if the material comprises a semi-crystalline polymer based upon a database; and
deactivating at least one of the one or more heaters when the semi-crystalline polymer is confirmed.

13. The method of claim 10, the step of molding a part comprising rotating the extrusion screw by one of a number of screw rotations and a screw rotation time selected according to the part size.

14. The method of claim 10, the operation of adjusting the heaters comprising:
rotating the extrusion screw to pump the material at the selected barrel temperature into a mold at to the selected screw rotation speed;
determining if the material temperature inside the barrel is high enough for molding from a torque sensor on a motor coupled to an end of the extrusion screw; and
adjusting the heaters.

15. The method of claim 14, the operation of determining if the material temperature is high enough, further comprising:
analyzing the torque load data from the torque sensor; and
adjusting the heaters until the torque load achieves a predetermined value.

16. The method of claim 15, the operation of analyzing the torque load data from the torque sensor received in the controller, further comprising disregarding spike signals until a predetermined stress load on the frame is achieved, the stress load being measured by a strain sensor on a frame housing an extrusion system and a mold system.

17. The method of claim 10, the operation of molding a part comprising:
receiving a signal from a machine in an assembly line to mold a part;
clamping a mold;
opening a nozzle to allow the material to flow into the mold;
continuously rotating the extrusion screw to pump the material into the mold;
determining if the mold is filled;
closing the nozzle to prevent the material from flowing into the mold;
cooling the mold; and
unclamping the mold to release the part.

18. The method of claim 17, wherein an injection pressure in the barrel is substantially the same or up to 10% higher than a pressure in the mold.

19. The method of claim 10, the operation of molding a part comprising:
clamping a mold;
activating the motor to rotate the extrusion screw to move the extrusion screw backward to open a nozzle to allow the material to flow into the mold;
continuously rotating the extrusion screw to pump the material at the adjusted temperature into the mold;
determining if the mold is filled;
reversing the motor to rotate the extrusion screw to move the extrusion screw forward to shut off the nozzle;
cooling the mold; and
unclamping the mold to release the part.

20. The method of claim 19, the operation of clamping the mold comprising applying an air pressure ranging from 90 psi to 110 psi to clamp the mold.

21. The method of claim 19, the operation of unclamping the mold comprising releasing an air pressure to unclamp the mold.

22. The method of claim 10, the operation of molding a part comprising:
clamping a mold;
moving the barrel forward relative to the extrusion screw to open a nozzle to allow the material to flow into the mold;
continuously rotating the extrusion screw to pump the material at the adjusted temperature into the mold;
determining if the mold is filled;
moving the barrel rearward relative to the extrusion screw to shut off the nozzle;
cooling the mold; and
unclamping the mold to release the part.

23. The method of claim 10, further comprising filling a hopper with the material to be molded; and cooling the hopper with a coolant prior to the step of switching on one or more heaters to heat a material inside the barrel to the selected barrel temperature.

24. The method of claim 10, wherein the material is selected from a group consisting of amorphous thermoplastics, crystalline and semi-crystalline thermoplastics, virgin resins, fiber reinforced plastics, recycled thermoplastics, post-industrial recycled resins, post-consumer recycled resins, mixed and comingled thermoplastic resins, organic resins, organic food compounds, carbohydrate based resins, sugar-based compounds, gelatin, propylene glycol compounds, starch based compounds, and metal injection molding (MIM) feedstocks.
